(19) United States
(12) Patent Application Publication
(10) Pub. No.: US 2026/0181242 A1
(43) Pub. Date: Jun. 25, 2026

(54) METHOD AND DEVICE FOR RESTRICTING PERSONAL INFORMATION IN A CAMERA IMAGE

(71) Applicant: MERCEDES-BENZ GROUP AG, Stuttgart (DE)

(72) Inventors: Lorenz WIDMANN, Schwäbisch Gmünd (DE); Sven FLECK, Sindelfingen (DE); Stefan KALCHMAIR, Aidlingen (DE); Sebastian SÄGER, Sindelfingen (DE); Emin TARAYAN, Sindelfingen (DE); Benjamin MAY, Lübs (DE)

(21) Appl. No.: 18/880,884

(22) PCT Filed: Jun. 26, 2023
(86) PCT No.: PCT/EP2023/067225

§ 371 Date: Jan. 3, 2025

(30) Foreign Application Priority Data
Jul. 5, 2022 (DE) 10 2022 002 448.9

(51) Int. Cl. H04N 23/63; G06V 20/56

(52) U.S. Cl. CPC H04N 23/63; G06V 20/56

(57) ABSTRACT

Personal information in a camera image from a camera unit used to carry out a vehicle function is reduced before the processing. Original image data from the camera unit are degraded in stages, each of which performs a type of degradation characteristic to the stage in question and has a changeable parameter for determining the intensity of the degradation. To determine the distribution of the degradation over the stages, a computing unit establishes the values of the parameters for each of the stages by means of an optimisation algorithm using i) the minimum information to be provided for the vehicle function and ii) a desired level of restriction of personal information, with i) and ii) being used as target values.

### BACKGROUND AND SUMMARY OF THE INVENTION

Exemplary embodiments of the invention relate to a method for reducing personal information in a camera image from a camera unit by means of degradation of the camera image, to a system for reducing personal information in a camera image from a camera unit by means of degradation of the camera image, and to a vehicle comprising such a system.

Image analysis methods in the field of what is known as “computer vision” enable the automatic processing of image data from a camera unit. For example, it is possible to determine whether and how many people are currently located in a capture range of the camera unit, objects can be recognized in the capture range, and the like; especially when used in the field of automated driving of vehicles or in driver assistance systems, such automated image analysis methods can also increase the safety on the roads and are sometimes compulsory for vehicle registration. For example, in some parts of the world, vehicle interior cameras are to be provided for certain, sometimes safety-relevant and registration-relevant use scenarios for vehicle functions, such as for monitoring the driver or occupants or for operating assistance systems that have to be constantly activated when the vehicle is travelling. This fundamentally leads to the dilemma that, in addition to the safety-related advantages offered by such an interior camera, there are obvious restrictions on the privacy of the occupants, in particular if it is possible in principle to identify the face of an occupant in the original camera images from the camera unit. While there is a risk of unauthorized access to the camera images by hacker attacks, the complete deactivation of camera units for operating vehicle functions or assistance systems is not possible. It is therefore desirable to safeguard the privacy of people appearing in the capture range of a camera unit, as well as other sensitive situations and objects, and simultaneously maintain the function of an automated application, a vehicle function or an assistance system that requires the presence of camera images from this camera unit.

U.S. Pat. No. 8,666,110 B2 relates to masking an image area containing private information. To this end, a relevant image excerpt containing private information is detected, and then this area is manipulated to make it unrecognizable. This relates in particular to the face of a person, a vehicle number plate, the window area of a house, or the like. To mask the image area, it can be encrypted and broken down/split up. It is also disclosed that a corresponding masking process can also be carried out in reverse in order to restore the original information in the captured image.

Exemplary embodiments of the invention are directed to guaranteeing efficient protection of sensitive data, while information from a camera image from a camera unit can still be used to carry out a vehicle function, such as an assistance system.

A first aspect of the invention relates to a method for reducing personal information in a camera image from a camera unit by means of degradation of the camera image, wherein the camera image processed by image analysis is used to carry out a vehicle function such as an assistance system, and wherein, in order to reduce personal information in the camera image, before the processing, original image data from the camera unit is degraded in stages of the image processing, each of the stages performing a type of degradation characteristic to the stage in question and each of the stages having at least one changeable parameter for determining the intensity of the degradation in the respective stage, wherein, in order to determine the distribution of the degradation over the stages, the values of the parameters for each of the stages are established by a computing unit by means of an optimization algorithm using i) the minimum information to be provided for the vehicle function and ii) a desired level of restriction of personal information, with i) and ii) being used as target amounts or target values and the parameters to achieve the target values being determined. The minimum information to be provided for the vehicle function represents a minimum requirement, in the case of which the vehicle function is available to the desired extent, i.e., for example without restriction, or with slight or considerable restriction.

The camera unit is preferably arranged on or in a vehicle and supplies camera images for a vehicle function, for example an automated application of the vehicle. Such a vehicle function is, for example, observing the passenger compartment for the purpose of determining the number of occupants in the vehicle, for personalizing functions of the vehicle by means of facial recognition, a fatigue warning system or the like. However, cameras can also be arranged on the vehicle exterior for providing visual data for a vehicle function, for example for recognizing road signs or categorizing road users in the vicinity of the vehicle into predefined categories such as cyclists, pedestrians, other vehicles etc.

For the above-mentioned use examples, a plurality of technically different chamber systems can be used for the camera unit. In particular, in each case, one from the following can be used: RGB camera, IR camera, FIR/NIR/thermal imaging camera, time-of-flight camera, stereo camera, structured light camera.

A multi-purpose interior cam (MPIC) is, for example, an interior camera arranged in the center console in the vehicle. The camera can supply signals to a plurality of systems: attention assist (driver observation for fatigue and distraction recognition, certification), driver assistance system with hands-free driving functions, personalization with driver and front passenger identification, or also interior assistant (person and gesture recognition), and other systems.

The camera images from the camera unit frequently contain not just the information for the vehicle function but also sensitive data relating to people's privacy. In particular, the personal information includes information suitable for identifying a person, such as information which is sufficient for facial recognition. However, in addition to information relating to the people themselves, object-related information can also contain sensitive data, such as vehicle number plates, house numbers, and other sensitive, private data.

Depending on the vehicle function, however, a certain degree of such personal information is not needed for carrying out the vehicle function. According to the invention, it is therefore proposed to degrade a certain amount of personal information, if possible, in the data path from the sensor of the camera unit to the processing computer unit, in particular a vehicle, to carry out the vehicle function in various stages. In this case, the information provided after the degradation must at least achieve the target value defined as information to be provided, in order to be of sufficient quality for carrying out the vehicle function.

The degradation of the camera images is carried out by algorithms or mechanisms characteristic for the stage, in order to degrade the respective camera image by editing steps such as image editing, i.e., to artificially transform the information that can be interpreted from the entirety of the pixels of the respective camera image into information that is less easy to interpret, i.e., to make personal data and personal information less easy to identify. The degradation is effected in particular by editing steps that include achieving a reduced resolution of the respective camera image, by applying overexposure, by means of an altered tone curve, by bilateral filters/guided filters/cartoonisation filters, or the like. Known methods of computational imaging and known image processing filter methods can also be used for the degradation.

As a result, in one exemplary embodiment, the degraded camera image obtained can be entirely color-shifted, noisy, and in low resolution compared with the original image data. In another exemplary embodiment, in which the original colors of the original image data would be considered important for faultless execution of the vehicle function, the parameters of the stages are preferably altered such that the original colors of the original image data are retained.

For each individual respective camera image, this necessitates a balancing act, i.e., a compromise to be found, between the aim of obtaining as much information as possible from the original image data in order to be able to ensure flawless functioning of the execution of the vehicle function, and the other aim of removing as much personal information as possible from the original image data. These are fundamentally competing aims, between which, in a first variant of the first aspect of the invention, a choice is made such that both function as target values in an optimization algorithm.

To this end, for example, a multi-aim optimization is carried out with aforementioned aims i) and ii) as respective target values, which in particular are optimized with weighting in a common cost function.

In an alternative or additional second variant of the first aspect of the invention, in the event that the two target variables cannot be achieved at the same time by changing the parameters, the optimization algorithm optimizes the parameters to the extent that, depending on the use case, either
the target value i) is achieved for the information provided for the vehicle function and the achieved level of restriction of personal information is as close to the target value ii) as possible or
the target value ii) is achieved for the level of restriction of personal information and the amount of information provided for the vehicle function is as close to the target value i) as possible. This variant can be used whenever no values can be found—or at least not within a predefined time—which enable both target values i) and ii) to be achieved at the same time.

Thus, according to the invention, the following alternatives are possible:
priority is given to privacy by restriction and removal of personal information in accordance with the target value ii) and being as close to the target value i) as possible for the vehicle function information to be provided, or
priority is given to the information to be provided for the vehicle function in accordance with the target value i) and being as close to the desired level of restriction ii) of personal information as possible.

Irrespective of whether the optimization algorithm solves a linear optimization problem analytically, solves a non-linear optimization problem iteratively, or executes a database-based solution (table, look-up table), the result is a distribution of the degradation of the original image data over the various stages with their respective characteristic methods for degradation. By determining the values for the parameters of a respective stage, the intensity of the degradation in a respective stage and thus for a respective characteristic type is specified. The problem space (determined by the number of the parameters in the stages) is typically multi-dimensional, however, and cannot typically be solved by a simple compromise such as a 1D parameter limit. There can be over one thousand parameters in total over a typically single-digit number of processing stages, but there can also be far more parameters.

Each of the stages thus has, in particular, at least one parameter, with the aid of which an extent or manner of degradation of the camera image can be determined that is specific to the stage in question. The sum total of all the parameters, after determining the values of the parameters, is used to determine a distribution of the degradation over the methods for degradation that are specific to the respective stages, i.e., what proportion of degradation each of the stages has in a current situation, in particular depending on the vehicle function.

The aim of the optimization algorithm is to determine the values of the parameters for the successive processing stages and thus to determine the distribution of the degradation over the stages, as well as the intensity of the degradation overall, and according to some embodiments (see further below) also the local intensity distribution of the degradation of the image data within the camera image.

It is therefore an advantageous effect of the invention that camera images, which are used to carry out a vehicle function, efficiently reduce personal information to a certain degree. The reduction efficiency is achieved in particular by splitting the reduction across various stages, with each of the individual stages providing certain mechanisms for reducing the personal information. The physical and logical properties of the respective stage can be optimally utilized depending on the limitations of the image properties and which and how much personal information is intended to be removed from the camera images. Furthermore, a compromise can be implemented between the competing requirements for the greatest possible protection of privacy with respect to the private information contained in the camera images on the one hand, and the highest possible proportion of information remaining in the camera images for the purpose of executing the vehicle function on the other hand. Advantageously, therefore, both the privacy requirements and the vehicle function requirements can be taken into account, in particular, such that the functional scope of the vehicle function only has accept minor losses, if any, while respecting privacy is significantly increased. There is thus a systematic way of optimizing the balance between data protection and the functionality of the application. An attacker is therefore in principle only able to determine degraded camera images from which the sensitive data has already been completely or considerably removed, however.

According to one advantageous embodiment, a measure for a preference between the minimum information to be provided for the vehicle function or a desired level of restriction of personal information and/or a prioritization of one of the target values is predefined by a user.

In other words, the user can predefine and influence a target amount or a target value for the level of functionality of the application by means of the quality of the information to be provided or a target amount or a target value for the level of personal information. The user can, for example, decide that they want a high level of restriction of personal data, i.e., that the image data includes very little personal data, or that they want extensive information transmitted by the image data for an unrestricted vehicle function.

This user stipulation is preferably performed on a graphical user interface of an operator control computer in a vehicle. A graphical element such as a control slider can be advantageous here, but discrete inputs made via check boxes on the graphical interface can also be used, depending on the situation and application.

In the event of safety-critical vehicle functions or vehicle functions legally required for licensing regulations, the target value can only be reduced to a minimum value or the person that is the user can also be restricted to development or workshop personnel. Advantageously, therefore, various user authorizations are provided for, in order to be able to perform the above-explained stipulation.

According to a further advantageous embodiment, a measure for a preference between the minimum information to be provided for the vehicle function and a desired level of restriction of personal information and/or a prioritization of one of the target variables is predefined by the computing unit, for example depending on the respective vehicle function, speed, driving situation, ambient conditions, etc.

In contrast to the above-described embodiment, the compromise between i) and ii) is made by the computing unit itself, namely depending on the respective vehicle function. Thus, for example, for the safety-critical vehicle function, a target value can be specified by the computing unit for the minimum information to be provided for the vehicle function, and the restriction of personal information can be maximized in the remaining leeway. This can also apply to individual aspects and be taken into account in the distribution of the degradation over the individual stages. If, for example, eye color is important for the vehicle function, then the computing unit will independently recognize that a color shift (which aids the restriction of personal information) may not be made in this particular configuration.

According to a further advantageous embodiment, the stages of the image processing include the following: the image sensor of the camera unit, in particular the register of the image sensors, hardware settings in the control unit of the camera unit, in particular calibration data, software processing in the control unit of the camera unit for algorithmic image editing.

The restriction of personal information is achieved over several stages. These preferably include, as outlined above, the stage of the sensor itself, since here personal information can be removed from the data directly at the source. The preferred algorithm in the stage of the sensor includes the following applications: 2×2 binning, 8× subsampling, high value saturation, 16× gain, image cropping, auto-exposure control and tone mapping for optimal privacy. A further preferred stage is realized by the hardware settings in the control unit of the camera unit, which is connected downstream of the sensor. This stage is realized in particular in hardware in the ECU (e.g., infotainment central computer). More complex algorithms are possible here for increasing the data protection than in the sensor, without impairing the vehicle function. By realizing this stage in hardware, it is advantageously well protected from external attackers. The preferred algorithm in the hardware stage includes the following applications: tone mapping for optimal privacy, minimal color saturation, sharpness reduction with edge preservation. A further preferred stage, which is downstream of the hardware settings in the control unit of the camera unit, is the software preprocessing in the control unit of the camera unit, which is ideally suited to flexible algorithmic image editing in order to remove personal data without impairing the vehicle function. Complex algorithms (e.g., neural networks) can be employed here in order to remove personal information from the data. Realizing this third stage in software makes this stage easier to attack, however. The preferred algorithm in the software stage includes the complex wavelet SSIM (CW_SSIM) application, where the abbreviation SSIM stands for “structural similarity index measure”. The CW_SSIM can be used as a metric for the information content. For this preferred algorithm, the filters and parameters described below are used to reduce personal information as much as possible, and this simultaneously safeguards the vehicle function by monitoring the CW_SSIM.

In a further embodiment, filters are used in the software processing stage in the control unit of the camera unit for the algorithmic image editing (in particular at least one from: noise filters, resharpening filters, scaling filters, tonal curve filters, brightness filters, color change filters), which are implemented by means of an artificial neural network with parameters for parameterizing the latter. To this end, generic steps are preferred, in particular in the form of CNNs (convolutional neuronal networks). By using known training methods (of sometimes millions of parameters), a seamless chain of CNNs can be globally optimized. The basic premise here is that for optimally carrying out the vehicle function, the camera image obtained for this stage does not necessarily have to appear particularly bright and neutral; instead, specific highlights (for instance of edges) can greatly improve the use of the information for the vehicle function due to its non-linear characteristic. Therefore, advantageously, this enhanced version makes an implementation possible which is not available at all through prefabricated “building blocks” (as is still the case in current series projects).

The respective algorithm for each stage is preferably adapted to the available maximum computing power of the computing unit, to used data formats, to security requirements, and the like. Because only a small amount of computing power is typically available in the above-mentioned preferred first stage, the sensor, simple algorithms are preferably implemented in this stage (e.g., saturate pixels in certain regions in order to remove personal information). The complexity of the applications in the above-mentioned further preferred stages tends to accordingly be chosen to be higher by the computing unit. The data is transmitted between the stages in particular via a physical channel (e.g., from the “sensor” stage to the “hardware settings” stage by means of a cable from the camera unit to the ECU).

In a further advantageous embodiment, for example a stage is used which is upstream of the sensor and in which external signals are directed specifically towards the sensor in order to subvert the sensor detection itself. In one preferred embodiment, an artificial worsening of the camera image is achieved by active light sources (change to the intensity and/or pattern of existing or additional lighting and/or projectors, preferably in the infrared range).

According to a further advantageous embodiment, the desired level of restriction of personal information is defined by means of a structural similarity index with respect to the camera image. According to this embodiment, the target value for the desired level of restriction of personal information is defined by means of what is known as a “structural similarity index measure” (SSIM). The following is used as a preferred measure to quantify the desired level of restriction:
(1-CW_SSIM), in words “one minus CW_SSIM” where “CW” stands for “complex wavelet” and “SSIM” for “structural similarity index measure”; further information on this topic can be found in the publication “Z. Wang and A. C. Bovik, “Mean squared error: Love it or leave it? A new look at Signal Fidelity Measures” in IEEE Signal Processing Magazine, vol. 26, no. 1, pp. 98-117, January 2009, doi: 10.1109/MSP.2008.930649”.

According to a further advantageous embodiment, the minimum information to be provided for the vehicle function comprises a mean standard deviation or a signal-to-noise ratio with respect to the camera image.

Further information on the topic of mean standard deviation (“MSE” for short) can also be found in the publication “Z. Wang and A. C. Bovik, “Mean squared error: Love it or leave it? A new look at Signal Fidelity Measures” in IEEE Signal Processing Magazine, vol. 26, no. 1, pp. 98-117, January 2009, doi: 10.1109/MSP.2008.930649”.

According to a further advantageous embodiment, a computing unit arranged in a vehicle is used, wherein continuously updated values of the parameters for each of the stages are established by the computing unit for a continuously updated determination of the distribution of the degradation over the stages.

The respectively current parameters, as established by the computing unit, are thus established on-board, i.e., locally in the vehicle itself. The continuously updated determination of the distribution of the degradation leads to the distribution of the degradation over the stages and the entire intensity of the degradation being adapted in real time. It is therefore advantageously possible to adapt to prevailing conditions, in order to be able to continuously optimally divide the information between the vehicle function and the aim of reducing personal information.

According to a further advantageous embodiment, the parameters for each of the stages are established by a computing unit depending on established situational parameters, wherein the situational parameters include, in particular, one of the following: distance of a face of a person from the camera unit, facial movements of a person relative to the camera unit, ambient conditions such as prevailing brightness levels, driving situation.

This means, in particular, that the restriction of personal information can be varied since, for example, a face close to a camera is more critical in terms of privacy than a face that is further away, for example on the rear seat of a vehicle in the dark. To this end, a prediction is preferably made by means of artificial intelligence or regression methods, even if a previously used reference image no longer exists during operation.

Establishing the values of the parameters for each of the stages for determining the distribution of the degradation over the stages by the optimization algorithm also advantageously takes place adaptively, in particular with respect to the geometric ROIs (regions of interest) for the vehicle function, in particular to maximize the ROI, that is to say information from this special region. This can change depending on the scene. Face ROIs can be determined with known algorithmic facial detections. Face detectors (for facial recognition) also exist in the prior art, which are very robust against reduction in spatial resolution. Furthermore, the unique properties of the respective vehicle function with respect to sensitivity of parameter values to certain image properties, such as noise, lack of structure, lack of contrast, can be taken into account. Furthermore, the expected or actual current scene (for instance regarding dynamic range, brightness distribution as represented in a histogram), in each case with respect to certain regions, can be used here for determining the values of the parameters in the optimization algorithm. Moreover, a different combination of parameter values can be employed in terms of location, time and content in each region of the camera image with the degradation a respective stage.

According to a further advantageous embodiment, values of the parameters of the stages for predefined camera images or for camera images from predefined scenes are specified by the computing unit and stored in a control unit of the vehicle.

Advantageously, according to this embodiment, if predefined camera images repeatedly occur or camera images from predefined scenes occur, the values of the parameters do not have to be redetermined, and instead a predefined set of predefined values of parameters can be accessed which have already been determined offboard in the past. Thus, superfluous computing effort can advantageously be saved. Predefined camera images can be used when it can be assumed that a situation that is almost the same as one captured by the camera unit will recur. Camera images from predefined scenes, by contrast, are more flexible to use and merely require matching features in the scenes. These sets of values of parameters, when they have been established, are stored in the control unit and assigned to the predefined camera images or to the predefined scenes and can be accessed by the computing unit in order to offer an alternative source to the optimization algorithm.

According to a further advantageous embodiment, the values of the parameters stored in the control unit are used for the degradation instead of the values of the parameters continuously updated by the computing unit only when a predefined camera image or a camera image from a predefined scene is present during operation.

According to a further advantageous embodiment, the computing unit determines the values of the parameters by means of a numerical, in particular iterative, method.

The iterative, numerical method is in particular advantageously used to iteratively approach predefined target values with respect to i) or ii), i.e. to change the values of the parameters until the required thresholds of the target values are met or at least one threshold i) or ii) of the target value is achieved and the other threshold is achieved as best as possible. In a multi-aim optimization, an iterative search algorithm can be used for non-linear optimization problems.

According to a further advantageous embodiment, the computing unit determines the values of the parameters by means of a pretrained artificial neural network.

In this case, the optimization algorithm uses a pretrained artificial neural network for determining the parameters. Possible input values for the pretrained artificial neural network are in particular the respective camera image and target values i) and ii); output values are parameters of the stages.

According to a further advantageous embodiment, the pretrained artificial neural network is continuously trained further on a server based on data from camera units of vehicles, wherein updates to the artificial neural network are transmitted back to vehicles in a fleet.

In a further preferred embodiment, the elements of the stages with their parameters are not only combined from a set of premade filters, but generated entirely by means of deep learning methods, analogously to generative adversarial networks (GANs). In an extended embodiment, additionally the hardware components are also taken into account in the target function by a further term. In this case, in particular, the resource expenditure is also mapped, in order to take account of this in the optimization algorithm—for example if the level of restriction of personal information remains the same with a similar (in particular to the extent that it essentially remains the same) quality and quantity of information to be provided for the vehicle function, the variant of parameters (in particular for selecting filter modules) selected is the one which can be carried out particularly efficiently on the computing unit or in the respective stage.

Another aspect of the invention relates to a system for reducing personal information in a camera image from a camera unit by means of degradation of the camera image, wherein the camera image processed by image analysis is used to carry out a vehicle function, in particular in a vehicle, and wherein, in order to reduce personal information in the camera image, a computing unit is designed to degrade, before the processing, original image data from the camera unit in stages, each of the stages performing a type of degradation characteristic to the stage in question and each of the stages having at least one changeable parameter for determining the intensity of the degradation in the respective stage, wherein, in order to determine the distribution of the degradation over the stages, the computing unit is designed to establish the values of the parameters for each of the stages by means of an optimization algorithm using i) the minimum information to be provided for the vehicle function and ii) a desired level of restriction of personal information, wherein i) and ii) are used as target values and the parameters to achieve the target values are determined.

Another aspect of the invention relates to a vehicle having a system as described above and in the following.

Advantages and preferred refinements of the proposed system become apparent from an analogous and corresponding transfer of the statements made above in connection with the proposed method.

Further advantages, features and details emerge from the following description, in which—where applicable with reference to the drawing—at least one exemplary embodiment is described in detail. Identical, similar and/or functionally identical parts are given the same reference signs.

### BRIEF DESCRIPTION OF THE DRAWING FIGURES

In the drawing:

FIG. 1: shows a method, carried out by a system, for reducing personal information in a camera image from a camera unit, according to an exemplary embodiment of the invention;

FIG. 2: shows the degradation stages used in the system, according to the exemplary embodiment in FIG. 1 in detail;

FIG. 3: shows a further embodiment of the degradation stages used in the system, according to the exemplary embodiment in FIG. 1; and

FIG. 4: shows a sequence of the method according to the invention.

### DETAILED DESCRIPTION

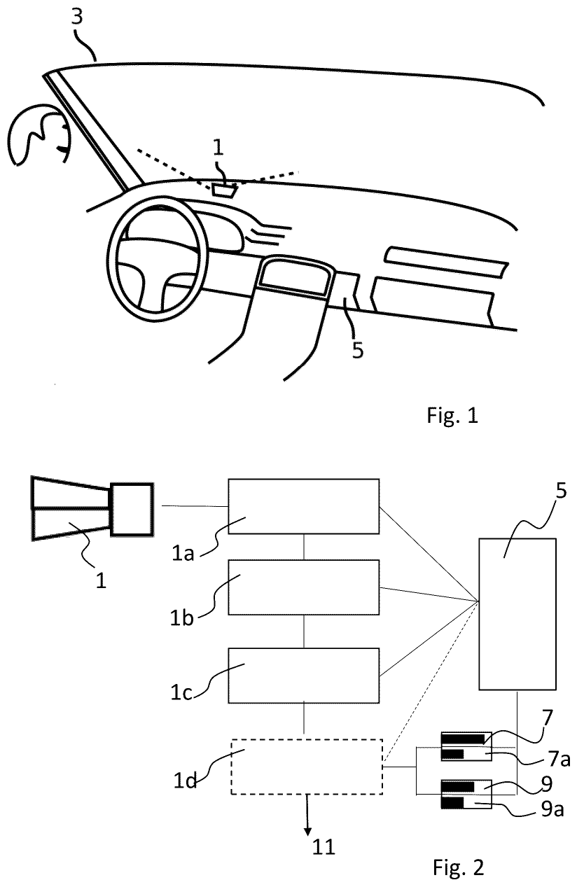

FIG. 1 shows the interior of a vehicle 3 comprising a camera unit 1 and a computing unit 5. The computing unit 5 is used to carry out a method for reducing personal information in a respective camera image from the camera unit 1 by means of degradation of the camera image. The camera image is generated by the camera unit 1 in high-frequency repetitions for the purpose of a vehicle function. A multi-purpose interior cam is used to perform a vehicle function such as automated fatigue warning. However, a secondary effect is that personal data is also captured, i.e., the data in the camera image that is sufficient in principle for facial recognition, automated or by a person, poses a security risk because an external attacker could gain access to this data, for example.

The aim is therefore to remove as much data which can be used to identify the filmed person in the respective camera image as possible, without impairing the vehicle function. To reduce personal information in the camera image before processing by the vehicle function, the original image data is degraded in processing stages of the camera unit 1, i.e., artificially made worse. Each of the stages performs a type of degradation that is characteristic of the state in question. In order to set which of the stages in a respective scenario and for a respective vehicle function adopts which proportion of the degradation and how great the degradation will be overall, each of the stages has a set of parameters with changeable values. This distribution is established by a computing unit 5 by establishing the values of the parameters for each of the stages for determining the distribution of the degradation over the stages by means of an optimization algorithm using i) the information to be provided for the vehicle function application and ii) a desired level of restriction of personal information. The competing aims i) and ii) are predefined as target values of an iterative, non-linear optimization algorithm for carrying out a multi-aim optimization, in order to achieve the target value i) for the information provided for the vehicle function and the target value ii) for the level of restriction of personal information. Alternatively, the parameters are optimized, so that either the target value i) is achieved for the information provided for the vehicle function and the level of restriction of personal information is as close to the target value ii) as possible or the target value ii) is achieved for the level of restriction of personal information i.e., the desired level of restriction is achieved and the information provided for the vehicle function is as close to the target value i) as possible.

The stages comprise the following: 1a an image sensor of the camera unit 1, in particular register of the image sensor; 1b hardware settings in the control unit of the camera unit 1, in particular calibration data, and 1c software processing in the control unit of the camera unit 1 for algorithmic image editing. Furthermore, an optional stage 1d (not explained in more detail) is shown, which comprises further parameterizable settings that influence the aims i) and ii), such as object illumination, post-editing stages etc. These are shown in more detail in FIG. 2. Proceeding from the camera unit 1, a plurality of methods are already employed in the first stage 1a in the sensor to modify the original camera image from the camera unit 1. Respective parameters in this stage relate to the above-mentioned image sensor of the camera unit 1. Methods such as 2×2 binning, 8× subsampling, high value saturation, 16× gain, exposure control, tone mapping for optimal privacy can be carried out in this case. The hardware settings in the control unit of the camera unit 1 represent the second stage 1b and have further parameters in the following methods: tone mapping for optimal privacy, minimal color saturation, sharpness reduction with edge preservation. In the third stage 1c, which is still upstream of the processing of the degraded image by the vehicle function, a complex wavelet SSIM (CW_SSIM) is used, where the abbreviation SSIM stands for “structural similarity index measure”. The parameter set with the values of the parameters of all stages is established as a complete set of parameters iteratively by the onboard computing unit 5 of the vehicle 3 specifically for each camera image.

To this end, the stages edited image recorded by the camera 1 are analyzed, by comparing the minimum information to be provided for the vehicle function i) as target value 7 for fulfilling a predefined range of functions with an actual value for the information 7a comprised in the image 7a, and by comparing a desired level of restriction of personal information ii) as target value 9 with an actual value of the image with respect to the level of personal data 9a. Provided that the actual values 7a, 9a are below the target values, the computing unit 5 optimizes the parameters of all stages 1a to 1d, for example in an iterative optimization process, until ideally the actual values of the information provided for the vehicle function by the image edited in the stages S1 to S4 and the level of personal data achieve at least the target values 7, 9 and then outputs the image 11.

If the target values 7, 9 cannot be achieved at the same time for the actual values of the information provided for the vehicle function and the level of personal data, then the parameters of the stages 1a to 1d are determined such that the target value i) is achieved for information provided at least for the vehicle function or the target value ii) is achieved for the level of restriction of personal information and the respectively other value is optimized as best as possible. In the case of safety-relevant functions such as driver observation, the information provided for the vehicle function is prioritized, so that it achieves the target value required for the function.

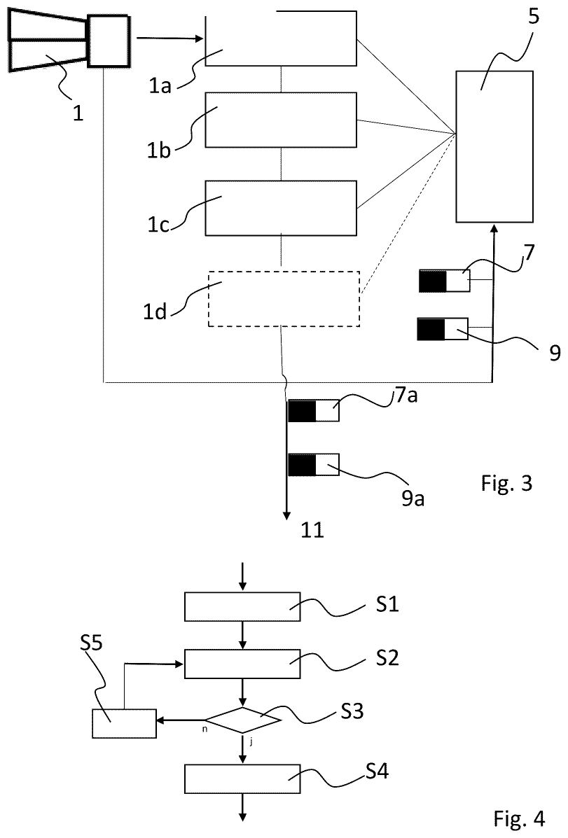

FIG. 3 shows an embodiment in which the optimization algorithm of the computing unit is embodied as a pretrained neural network. The neural network is configured, based on an image recorded by the camera 1 and predefined target values i) for the minimum information 7 to be provided for the vehicle function and a desired level of restriction of personal information 9, to determine the parameters of the stages 1a to 1d in such a way that the image 11 edited in the stages 1a to 1d and subsequently output provides the information 7a required for the vehicle function and complies with the desired level of restriction of personal information 9a.

FIG. 4 shows an example of a sequence of the method according to the invention, wherein an image is received in step S1, and the image is edited in the stages 1a to 1d with predefined image editing parameters in step S2. In step S3 it is checked whether the information provided by the image for the vehicle function achieves the target value i), i.e., the vehicle function minimum information (7) to be provided, and whether the level of restriction of personal information of the image achieves the desired level of restriction of personal information. If the check returns a positive result, then the image is output in step S4. If the check in S3 returns a negative result, then the image editing parameters are changed by the optimization algorithm of the computing unit 5 in step S5 and transmitted to the stages 1a to 1d. In step S2, the image is edited with the changed parameters, and then, in step 3, compared with the target values i) and ii) again. The optimization in step S5 is effected until the target values i) and ii) are achieved and the image can then be output in step 4.

Although the invention has been illustrated and explained in detail by preferred exemplary embodiments, the invention is not restricted by the disclosed examples and a person skilled in the art can derive other variations therefrom without departing from the scope of protection of the invention. It is therefore clear that a plurality of possible variations exists. It is likewise clear that embodiments mentioned by way of example are really only examples which are not in any way to be regarded as limiting the scope of protection, the use scenarios or the configuration of the invention for example. Rather, the above description and the description of the figures enable a person skilled in the art to actually implement the exemplary embodiments, wherein a person skilled in the art, with knowledge of the disclosed inventive concept, can undertake a variety of changes, for example regarding the function or the arrangement of individual elements mentioned in an exemplary embodiment, without departing from the scope of protection defined by the claims and their legal equivalents, such as further explanations in the description.

1-16. (canceled)

17. A method comprising:
reducing personal information in a camera image from a camera unit of a vehicle by degrading the camera image,
wherein the camera image processed by image analysis is used to perform a function of the vehicle,
wherein, the personal information is reduced, prior to the processing of the camera image by image analysis, the method comprises degrading original image data from the camera unit in stages,
wherein each of the stages involve performing a type of degradation characteristic,
wherein each of the stages has at least one changeable parameter for determining an intensity of the degradation in the respective stage,
wherein, in to determine distribution of the degradation over the stages, values of parameters for each of the stages are established by a computing unit by an optimization algorithm using
i) minimum information to be provided for the vehicle function, and
ii) a desired level of restriction of personal information,
wherein i) and ii) are used as target values, and
wherein the parameters to achieve the target values are determined.

18. The method of claim 17, wherein, when two of the target values cannot be achieved at a same time by changing the parameters, the optimization algorithm optimizes the parameters to an extent that, depending on use case, either
the target value i) is achieved for the minimum information provided for the vehicle function and the level of restriction of personal information is as close to the target value ii) as possible, or
the target value ii) is achieved for the level of restriction of personal information and the minimum information provided for the vehicle function is as close to the target value i) as possible.

19. The method of claim 17, wherein a measure for a preference between the minimum information to be provided for the vehicle function, a desired level of restriction of personal information, or a prioritization of one of the target values is predefined by a user.

20. The method of claim 17, wherein a measure for a preference between the minimum information to be provided for the vehicle function, a desired level of restriction of personal information, or a prioritization of one of the target values is predefined by the computing unit.

21. The method of claim 17, wherein the stages include:
an image sensor of the camera unit,
hardware settings in a control unit of the camera unit, and
software processing in the control unit of the camera unit for algorithmic image editing.

22. The method of claim 17, wherein the desired level of restriction of personal information is defined by a structural similarity index with respect to the camera image.

23. The method of claim 17, wherein the minimum information for the vehicle function comprises a mean standard deviation or a signal-to-noise ratio with respect to the camera image.

24. The method of claim 17, wherein the computing unit is arranged in the vehicle, wherein continuously updated values of the parameters for each of the stages are established by the computing unit for a continuously updated determination of the distribution of the degradation over the stages.

25. The method of claim 24, wherein the parameters for each of the stages are established by the computing unit depending on established situational parameters, wherein the established situational parameters include:
distance of a face of a person from the camera unit,
facial movements of a person relative to the camera unit,
ambient conditions, or
driving situation.

26. The method of claim 17, wherein values of the parameters of the stages for predefined camera images or for camera images from predefined scenes are specified by the computing unit and stored in a control unit of the vehicle.

27. The method of claim 26, wherein the values of the parameters stored in the control unit of the vehicle are used for the degradation instead of the values of the parameters continuously updated by the computing unit when a predefined camera image or a camera image from a predefined scene is present during operation.

28. The method of claim 17, wherein the computing unit determines the values of the parameters by a numerical method.

29. The method of claim 17, wherein the computing unit determines the values of the parameters using a pretrained artificial neural network.

30. The method of claim 29, wherein the pretrained artificial neural network is continuously trained further on a server based on data from camera units of other vehicles, wherein updates to the artificial neural network are transmitted back to the other vehicles in a fleet.

31. A system comprising:
a vehicle camera unit configured to capture a camera image; and
a vehicle computing unit configured to process, by image analysis, the camera image to perform a function of the vehicle,
wherein the system is configured to reduce personal information in the camera image from the vehicle camera unit by degrading the camera image,
wherein, the personal information is reduced, prior to the processing of the camera image by image analysis,
wherein original image data from the camera unit is degraded in stages,
wherein each of the stages involve performing a type of degradation characteristic,
wherein each of the stages has at least one changeable parameter for determining an intensity of the degradation in the respective stage,
wherein, in to determine distribution of the degradation over the stages, values of parameters for each of the stages are established by a computing unit by an optimization algorithm using
i) minimum information to be provided for the vehicle function, and
ii) a desired level of restriction of personal information,
wherein i) and ii) are used as target values, and
wherein the parameters to achieve the target values are determined.

32. A vehicle comprising:
a system, which comprises
a vehicle camera unit configured to capture a camera image; and
a vehicle computing unit configured to process, by image analysis, the camera vehicle image to perform a function of the vehicle,
wherein the system is configured to reduce personal information in the camera image from the vehicle camera unit by degrading the camera image,
wherein, the personal information is reduced, prior to the processing of the camera image by image analysis,
wherein original image data from the camera unit is degraded in stages,
wherein each of the stages involve performing a type of degradation characteristic,
wherein each of the stages has at least one changeable parameter for determining an intensity of the degradation in the respective stage,
wherein, in to determine distribution of the degradation over the stages, values of parameters for each of the stages are established by a computing unit by an optimization algorithm using
i) minimum information to be provided for the vehicle function, and
ii) a desired level of restriction of personal information,
wherein i) and ii) are used as target values, and
wherein the parameters to achieve the target values are determined.
